(19) United States
(12) Patent Application Publication
(10) Pub. No.: US 2022/0076904 A1
(43) Pub. Date: Mar. 10, 2022

(54) KEY STRUCTURE AND ELECTRONIC APPARATUS

(71) Applicant: SHARP KABUSHIKI KAISHA, Osaka (JP)

(72) Inventor: JUNYA TAKAHASHI, Osaka (JP)

(21) Appl. No.: 17/459,940

(22) Filed: Aug. 27, 2021

(30) Foreign Application Priority Data
Sep. 9, 2020 (JP) 2020-151468

(51) Int. Cl. H01H 13/20; H01H 13/04

(52) U.S. Cl. CPC H01H 13/20; H01H 13/04

(57) ABSTRACT

A key structure comprises at least one key switch mounted on a surface of a substrate disposed inside a case of an electronic apparatus; at least one key top inserted in a key through-hole bored in the case, the at least one key top being designed to press the at least one key switch upon undergoing a displacement from outside the case toward inside the case; and a key stopper abutting, inside the case, the at least one key top that has undergone the displacement, to restrict a further outward-to-inward displacement of the at least one key top.

### CROSS-REFERENCE TO RELATED APPLICATION

The present application claims priority from Japanese Patent Application Number 2020-151468, the content of which is hereby incorporated by reference into this application.

### BACKGROUND

### Field

The disclosure relates to a key structure and an electronic apparatus.

### Description of the Related Art

Known electronic apparatuses are known to incorporate a key structure, which is a press-operated switch structure. Japanese Patent Application Laid-Open No. 2017-208199 for instance discloses a key structure that includes a key switch disposed inside the case of an electronic apparatus, and a key top inserted in a key through-hole bored in the case.

In such a key structure provided so as to be pressed in a direction parallel to a surface of a substrate of the electronic apparatus, the key switch is typically mounted while fitting in a cut disposed in the substrate. The cut in this case can absorb, at its edge, the impact of key-top hitting against the key switch.

### SUMMARY

The key switch can be mounted onto the substrate surface, when the electronic apparatus undergoes a layout change to thus change the placement of the key structure to a direction remote from the substrate surface.

Mounting the key switch onto the substrate surface without any creative thinking unfortunately fails to absorb the impact of key-top hitting against the key switch at the cut edge. The key switch hence directly receives the impact to destroy or to cause solder joining the key switch and substrate together to fall off, thus establishing faulty conduction.

It is an object of one aspect of the disclosure to achieve a key structure and other things that are tough to impacts with a key switch mounted on a substrate surface.

To solve the above problem, one aspect of the disclosure provides a key structure that includes the following: at least one key switch mounted on a surface of a substrate disposed inside a case of an electronic apparatus; and at least one key top inserted in a key through-hole bored in the case. The at least one key top is designed to press the at least one key switch upon undergoing a displacement from outside the case toward inside the case. The key structure also includes a key stopper abutting, inside the case, the at least one key top that has undergone the displacement, to restrict a further outward-to-inward displacement of the at least one key top.

The aspect of the disclosure achieves a key structure and other things that are tough to impacts with a key switch mounted on a substrate surface.

### BRIEF DESCRIPTION OF THE DRAWINGS

FIG. 1 is a front view of the appearance of a smartphone according to a first preferred embodiment of the disclosure;

FIG. 2 is an exploded perspective view of a key structure according to the first preferred embodiment of the disclosure;

FIG. 3 is a partial enlarged view of a key stopper according to the first preferred embodiment of the disclosure;

FIG. 4 is a leftward-enlarged perspective view of the key structure according to the first preferred embodiment of the disclosure;

FIG. 5 is a front view of the initial state of a second key top and third key switch, both included in the key structure according to the first preferred embodiment of the disclosure;

FIG. 6 is a front view of the second key top and third key switch, included in the key structure according to the first preferred embodiment of the disclosure, under displacement restriction;

FIG. 7 illustrates how a third key switch and a substrate, both included in a key structure according to a second preferred embodiment of the disclosure, are connected together; and

FIG. 8 illustrates how a key stopper and the substrate, both included in the key structure according to the second preferred embodiment of the disclosure, are connected together.

### DETAILED DESCRIPTION

### First Preferred Embodiment

### Smartphone Configuration

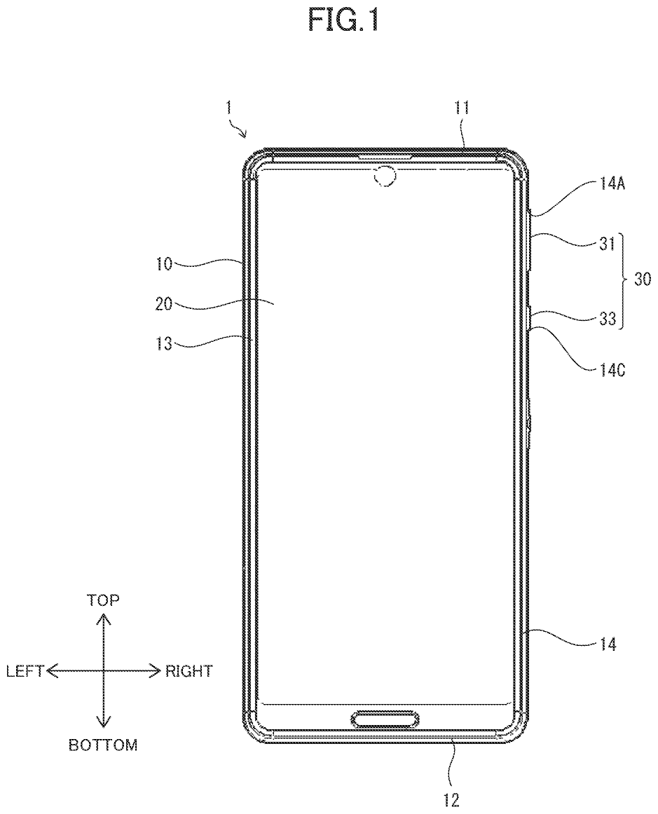

One preferred embodiment of the disclosure will be detailed. FIG. 1 is a front view of the appearance of a smartphone (electronic apparatus) 1 according to this preferred embodiment. The smartphone 1 includes a case 10, a display 20, and a key structure 30, as illustrated in FIG. 1. In the following description, a direction toward a viewer on the drawing sheet of FIG. 1 will be referred to as a front side, and a direction remote from the viewer on the drawing sheet will be referred to as a back side.

The following preferred embodiment describes, by way of example, the smartphone 1 incorporating the key structure 30 according to one preferred embodiment of the disclosure. However, an electronic apparatus that can incorporate the key structure 30 is not limited to the smartphone 1. Examples of such an electronic apparatus include a mobile phone, a tablet terminal, a personal handy-phone system (PHS), a personal digital assistant (PDA), a personal computer, a mobile tool, a computerized dictionary, a calculator, and a gaming console. Although having a first key top 31 and a second key top 33 by way of example, the key structure 30 may have only one key top.

The case 10 has a back wall (not shown) having a substantially rectangular plate shape and has an upper wall 11, lower wall 12, left wall 13 and right wall 14 protruding forward from the back wall. The display 20 is attached to the front ends of the upper wall 11, lower wall 12, left wall 13 and right wall 14. The case 10 contains a substrate 40 (described later on and not shown in FIG. 1) disposed between its back wall and the display 20.

The case 10 has a first key through-hole 14A and a second key through-hole 14C both bored in the right wall 14 and penetrating in the side-to-side direction. The first key through-hole 14A and the second key through-hole 14C are arranged in the up-and-down direction in this order from the top. The first key through-hole 14A and the second key through-hole 14C are located closer to the display 20 than the back wall of the case 10. The display 20 is a liquid crystal screen or LED screen including a touch panel for instance.

The key structure 30 includes the first key top 31 and the second key top 33. In other words, the key structure 30 includes a plurality of key tops 31 and 33. The first key top 31 and the second key top 33 are disposed on the right wall 14 of the case 10 as side keys of the smartphone 1. The first key top 31 is longer than the second key top 33 in the up-and-down direction. The first key top 31 is inserted in the first key through-hole 14A, and the second key top 33 is inserted in the second key through-hole 14C. The first key top 31 and the second key top 33 thus have their left sides corresponding to the inside of the case 10 with reference to the right wall 14 of the case 10. These key tops 31 and 33 also have their right sides corresponding to the outside of the case 10 with reference to the right wall 14 of the case 10.

### Key Structure Configuration

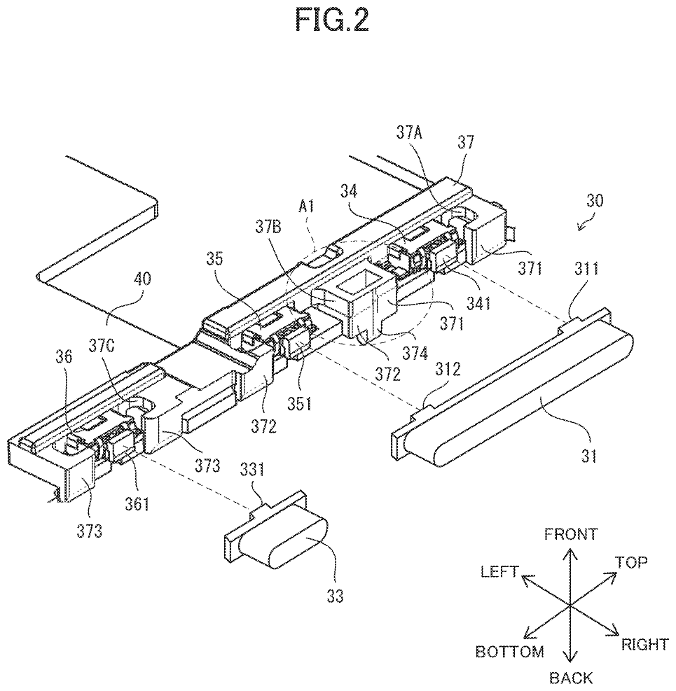

FIG. 2 is an exploded perspective view of the key structure 30 according to this preferred embodiment. In addition to the first key top 31 and second key top 33, the key structure 30 includes a first key switch 34, a second key switch 35, a third key switch 36, and a key stopper 37, as illustrated in FIG. 2. The key structure 30 thus includes a plurality of key switches 34, 35 and 36. The first key switch 34, the second key switch 35, and the third key switch 36 are arranged in the up-and-down direction in this order from the top.

The first key top 31 has a first protrusion 311 protruding toward the left where the first key switch 34 is located, and a second protrusion 312 protruding toward the left where the second key switch 35 is located. The first protrusion 311 is located above the second protrusion 312. The second key top 33 has a third protrusion 331 protruding toward the left where the third key switch 36 is located.

The first key switch 34, the second key switch 35, and the third key switch 36 are mounted on the front surface of the substrate 40. The first key switch 34, the second key switch 35, and the third key switch 36 are joined to the substrate 40 with, for instance, solder. In addition to the first key switch 34, second key switch 35 and third key switch 36, the substrate 40 is provided with various electronic components (not shown) used for controlling the smartphone 1.

The first key switch 34 has a first button 341 protruding rightward. The position of the first button 341 in the up-and-down and fore-and-aft directions corresponds to the position of the first protrusion 311. That is, the first key top 31 and the first key switch 34 are designed such that the first protrusion 311 presses the first button 341 upon displacement of the first key top 31 from the right toward the left.

The second key switch 35 has a second button 351 protruding rightward. The position of the second button 351 in the up-and-down and fore-and-aft directions corresponds to the position of the second protrusion 312. That is, the first key top 31 and the second key switch 35 are designed such that the second protrusion 312 presses the second button 351 upon displacement of the first key top 31 from the right toward the left.

The third key switch 36 has a third button 361 protruding rightward. The position of the third button 361 in the up-and-down and fore-and-aft directions corresponds to the position of the third protrusion 331. That is, the second key top 33 and the third key switch 36 are designed such that the third protrusion 331 presses the third button 361 upon displacement of the second key top 33 from the right toward the left.

The key stopper 37 is elongated in the up-and-down direction and is attached to the front surface of the substrate 40. The key stopper 37 in this preferred embodiment is shared among the first key switch 34, second key switch 35, third key switch 36, first key top 31 and second key top 33. In some preferred embodiments, the key stopper 37 does not necessarily have to be shared among a plurality of key switches and a plurality or key tops.

The key stopper 37 has a first opening 37A, a second opening 37B, and a third opening 37C, all passing from the front surface of the key stopper 37 through the back surface of the key stopper 37 and each having a right side surface that is open. The first opening 37A, the second opening 37B, and the third opening 37C are located in the up-and-down direction in this order from the top. The first key switch 34 is disposed on the inside of the first opening 37A with the first button 341 facing the open right side. The second key switch 35 is disposed on the inside of the second opening 37B with the second button 351 facing the open right side. The third key switch 36 is disposed on the inside of the third opening 37C with the third button 361 facing the open right side.

The key stopper 37 has a right side surface on which a first abutment 371, a second abutment 372, and a third abutment 373 are disposed. The first abutment 371 is disposed at two locations in the up-and-down direction (a direction orthogonal to the direction of displacement and to the direction of the normal to the substrate) with the first key switch 34 interposed therebetween. The second abutment 372 is disposed at two locations in the up-and-down direction with the second key switch 35 interposed therebetween. The third abutment 373 is disposed at two locations in the up-and-down direction with the third key switch 36 interposed therebetween.

The first abutments 371 abut the upper part of the first key top 31 displaced from the right toward the left, to restrict a further rightward-to-leftward displacement of the first key top 31. The second abutments 372 abut the lower part of the first key top 31 displaced from the right toward the left, to restrict a further rightward-to-leftward displacement of the first key top 31. The third abutments 373 abut the second key top 33 displaced from the right toward the left, to restrict a further rightward-to-leftward displacement of the second key top 33.

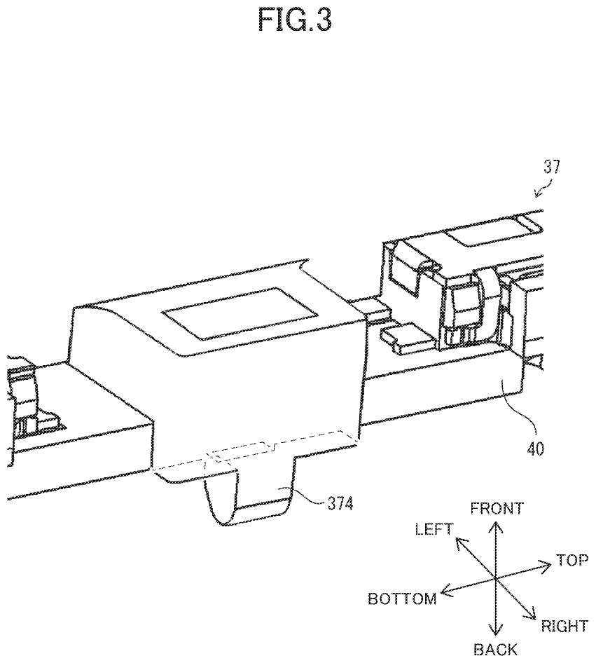

FIG. 3 is an enlarged view of a region A1 in FIG. 2. The key stopper 37 has a nail 374, as illustrated in FIG. 3. The nail 374 in this preferred embodiment is disposed on the right side surface of the key stopper 37 corresponding to the edge of the substrate 40, and the nail 374 is engaged in the back surface of the substrate 40. The nail 374 is engaged in the back surface of the substrate 40, thus attaching the key stopper 37 to the substrate 40.

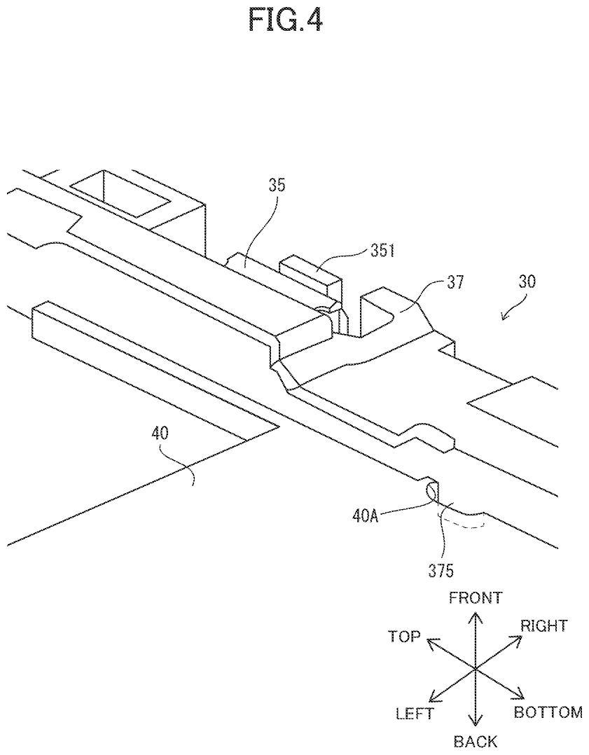

FIG. 4 is a leftward-enlarged perspective view of a main component of the key stopper 37 of the key structure 30 according to this preferred embodiment. The key stopper 37 further has a positioning pin 375, as illustrated in FIG. 4. The positioning pin 375 in this preferred embodiment is disposed on the left side surface of the key stopper 37. The positioning pin 375 is inserted in a positioning hole 40A, bored in the substrate 40, thus positioning the key stopper 37 in the substrate 40. Herein, the first key top 31 is omitted in FIG. 4.

### Key Structure Operation

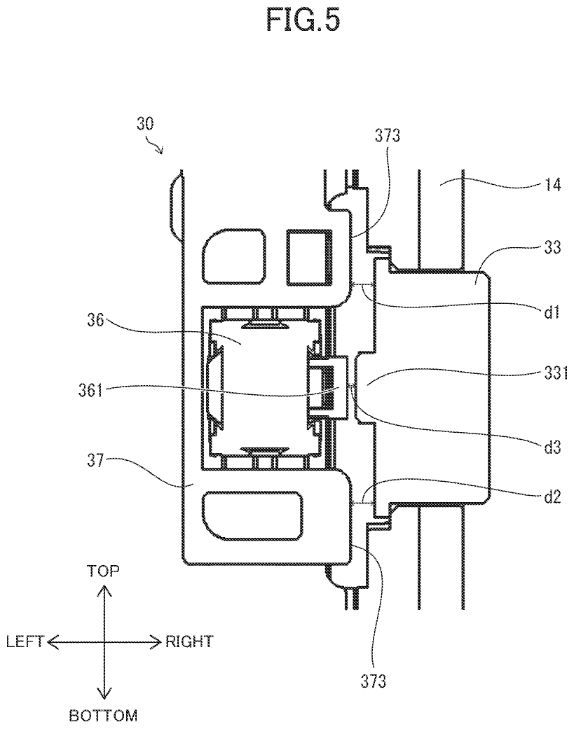

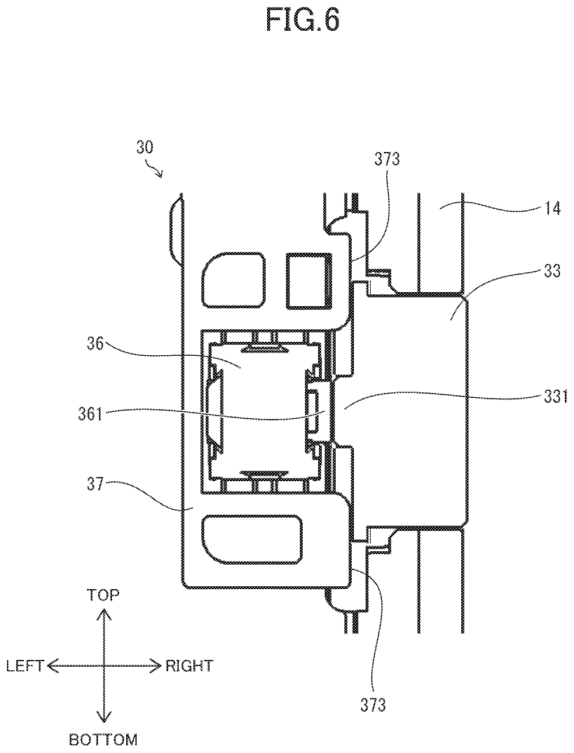

FIG. 5 is a front view of the initial state of the second key top 33 and third key switch 36 of the key structure 30 according to this preferred embodiment. FIG. 6 is a front view of the second key top 33 and third key switch 36 according to this preferred embodiment under displacement restriction. The following focuses attention on the second key top 33 and third key switch 36 by way of example, to describe the operation of the key structure 30. How the key structure 30 operates is similar with regard to the first key top 31 and first key switch 34 and to the first key top 31 and second key switch 35. Moreover, a key top under displacement herein refers to a key top under stroke.

In the initial state of the second key top 33 and third key switch 36, the second key top 33 is biased rightward by an elastic member (not shown) for instance, as illustrated in FIG. 5. The second key top 33 is hence rightward remote from the third key switch 36 and key stopper 37.

At this time, a distance d1 between the second key top 33 and upper third abutment 373 is equal to a distance d2 between the second key top 33 and lower third abutment 373. In addition, a distance d3 between the third protrusion 331 and third button 361 is shorter than the distance d1. The distance d1 is set in such a manner that the difference between the distances d1 and d3 (d1−d3) falls within a recommended stroke amount established for the third key switch 36. The recommended stroke amount herein refers to a stroke amount in which a key switch (e.g., the third key switch 36) can be switched and does not surfer a breakdown.

In the initial state of the second key top 33 and third key switch 36, the second key top 33 is leftward displaced from the right upon being pressed leftward (toward the inside of the case 10), thus causing the third protrusion 331 to abut the third button 361. The second key top 33 and the third abutment 373 are distant from each other at this stage. In addition, the stroke amount of the third key switch 36 remains zero.

Upon a further rightward-to-leftward displacement of the second key top 33, the third protrusion 331 presses the third button 361, and the third abutment 373 abuts the second key top 33. The third abutment 373 at this time abuts the second key top 33 to restrict a further rightward-to-leftward displacement of the second key top 33. The second key top 33 and the third key switch 36 are thus under displacement restriction.

The stroke amount of the third key switch 36 is equal to the difference between the distances d1 and d3 (d1−d3) while the second key top 33 and the third key switch 36 remain under displacement restriction. As earlier described, the distance d1 is set in such a manner that this difference (d1−d3) falls within the recommended stroke amount for the third key switch 36. The stroke amount of the third key switch 36 under displacement restriction hence falls within the recommended stroke amount. This configuration can switch the third key switch 36 and avoid the third key switch 36 from a breakdown. The configuration can also reduce a load exerted on the connected portion between the third key switch 36 and substrate 40, reduce removal of solder and other things and avoid faulty conduction, when compared to an instance where no key stopper 37 is provided.

The third abutment 373 is disposed at two locations in the up-and-down direction with the third key switch 36 interposed therebetween. This configuration can downsize the key structure 30 in the fore-and-aft direction when compared to an instance where, for instance, an abutment is disposed at two locations in the fore-and-aft direction with the third key switch 36 interposed therebetween. This achieves a slimmed-down version of the smartphone 1.

The key stopper 37 is shared among the first key switch 34, the second key switch 35, the third key switch 36, the first key top 31, and the second key top 33. This configuration offers a reduced number of process steps for assembling the key structure 30 and facilitates the assembly, when compared to an instance where the key stopper 37 is independently provided for each of the first key top 31, second key top 33 and the other components. This achieves the key structure 30 that can be manufactured effectively.

### Second Preferred Embodiment

Another preferred embodiment of the disclosure will be detailed. For convenience in description, components having the same functions as those described in the first preferred embodiment will be denoted by the same signs and will not be elaborate upon here.

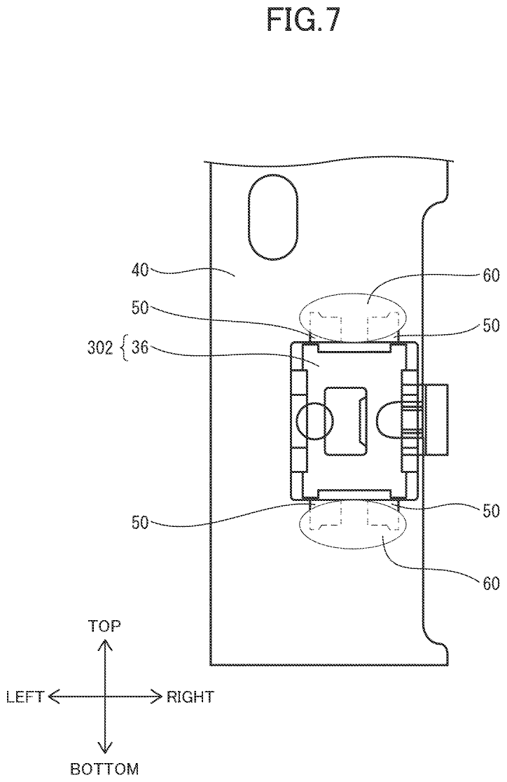

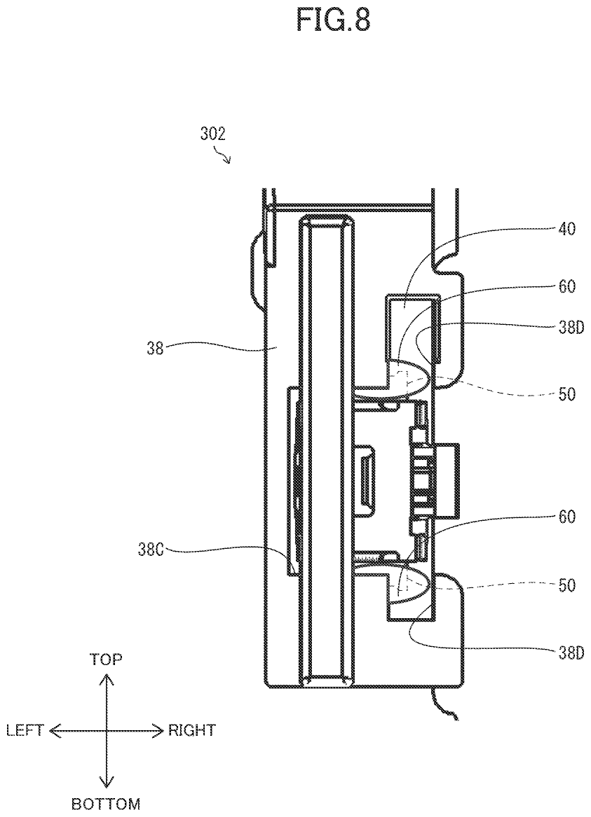

FIG. 7 illustrates how a third key switch 36 and a substrate 40, both included in a key structure 302 according to this preferred embodiment, are connected together. FIG. 8 illustrates how a key stopper 38 and the substrate 40, both included in the key structure 302 according to this preferred embodiment, are connected together. FIGS. 7 and 8 are front views of the key structure 302. As illustrated in FIGS. 7 and 8, the key structure 302 according to the second preferred embodiment is configured such that the key stopper 38 is fixed to the substrate 40 by an adhesive 60 applied to a joint 50, where the electrodes of the third key switch 36 and substrate 40 are joined together.

To be specific, FIG. 7 shows the adhesive 60 applied to the joint 50, where the electrodes of the third key switch 36 and substrate 40 are joined together. The joint 50 can be applied with solder for instance. Although FIG. 7 illustrates, by way of example, that the joint 50 is disposed at four locations in total: the upper right, upper left, lower right and lower left of the third key switch 36, the disclosure is not limited to this example. Moreover, the adhesive 60 can be any adhesive; for instance, a thermosetting resin can be used.

As illustrated in FIG. 8, the key stopper 38 of the key structure 302 has an application opening 38D disposed at two locations on its top and bottom and communicating to the right side of the third opening 38C. Like the third opening 38C, the application openings 38D pass from the front surface through the back surface and expose the joints 50 partly frontward. Pouring the adhesive 60 from the application openings 38D enables the adhesive 60 to be applied to the joints 50. Moreover, when viewed from the front, the key stopper 38 partly overlaps the adhesive 60 applied to the joints 50.

This configuration offers the key stopper 38 fixed to the substrate 40 by the adhesive 60 applied to the joints 50. The key stopper 38 may be made of any material; for instance, a polycarbonate can be used. Nevertheless, when a thermosetting resin is used as the adhesive 60, the key stopper 38 is preferably made of a heat-resistant material. An example of the heat-resistant material usable is a poly-phenylene-sulfide (PPS) resin. A heat-resistant material can avoid the key stopper 38 from deterioration or shape transformation when the adhesive 60, a thermosetting resin, is thermally cured.

In the foregoing configuration, the adhesive 60 is applied to the joints 50, where the electrodes of the third key switch 36 and substrate 40 are joined together, thereby achieving enhanced strength of the joints 50. In addition, the key stopper 38, which is fixed to the substrate 40 by the adhesive 60 applied to the joints 50, can avoid a backlash between the key stopper 38 and substrate 40 without the need for an additional separate process step for fixing the key stopper 38 to the substrate 40. The key stopper 38 can thus absorb, with more certainty, the impact of hitting of the second key top 33 (not shown in FIGS. 7 and 8) against the third key switch 36. This can avoid the smartphone 1 from a breakdown with more certainty.

The foregoing has described the third key switch 36 with reference to FIGS. 7 and 8. Like the third key switch 36, the first key switch 34 and the second key switch 35 may be fixed by an adhesive.

### SUMMARY

The key structure 30 or 302 according to a first aspect of the disclosure includes the following: the key switch 34, 35, or 36 mounted on a surface of the substrate 40 disposed inside the case 10 of an electronic apparatus (smartphone 1); and the key top 31 or 33 inserted in the key through-hole 14A or 14C bored in the case 10. The key top 31 or 33 is designed to press the key switch 34, 35, or 36 upon undergoing a displacement from outside the case 10 toward inside the case 10. The key structure 30 or 302 also includes a key stopper 37 or 38 abutting, inside the case 10, the key top 31 or 33 that has undergone the displacement, to restrict a further outward-to-inward displacement of the key top 31 or 33.

In the foregoing configuration, the key stopper 37 abuts the key top 31 or 33 to restrict a further outward-to-inward displacement of the key top 31 or 33. This can avoid the key switch 34, 35 or 36 from a breakdown. The configuration can also reduce a load exerted on the connected portion between the substrate 40 and the key switch 34, 35 or 36, thus reducing removal of solder and other things and avoiding faulty conduction. This can avoid the electronic apparatus (smartphone 1) from a breakdown.

In the first aspect, the key structure 30 or 302 according to a second aspect of the disclosure may be configured such that the key stopper 37 or 38 has the abutment 371, 372 or 373 where the key stopper 37 or 38 abuts the key top 31 or 33, and such that the abutment 371, 372 or 373 is disposed at two locations in a direction (up-and-down direction) orthogonal to the direction of the displacement (side-to-side direction) and to the direction of the normal to the substrate (fore-and-aft direction), with the key switch 34, 35 or 36 interposed between the two locations.

In the foregoing configuration, the abutment 371, 372 or 373 is disposed at two locations in a direction (up-and-down direction) orthogonal to the direction of the displacement (side-to-side direction) and to the direction of the normal to the substrate 40 (fore-and-aft direction), with the key switch 34, 35 or 36 interposed between the two locations. This configuration can downsize the key structure 30 or 302 in the direction of the normal to the substrate 40 (fore-and-aft direction) when compared to an instance where, for instance, an abutment is disposed at two locations in the fore-and-aft direction with the third key switch 34, 35 or 36 interposed therebetween. This achieves a slimmed-down version of the electronic apparatus (smartphone 1).

In the first or second aspect, the key structure 30 or 302 according to a third aspect of the disclosure may include a plurality of key switches 34, 35 and 36, and a plurality of key tops 31 and 33. The key structure 30 or 302 may be configured such that the key stopper 37 or 38 is shared among the plurality of key switches 34, 35 and 36 and the plurality of key tops 31 and 33.

In the foregoing configuration, the key stopper 37 is shared among the plurality of key switches 34, 35 and 36 and the plurality of key tops 31 and 33. This configuration offers a reduced number of process steps for assembling the key structure 30 or 302 and facilitates the assembly, when compared to an instance where the key stopper 37 is independently provided for each of the first key top 31, second key top 33 and the other components. This achieves the key structure 30 or 302 that can be manufactured effectively.

An electronic apparatus (smartphone 1) according to a fourth aspect of the disclosure may include the key structure 30 or 302 according to any one of the first to third aspects. This configuration can embody an electronic apparatus (smartphone 1) that includes the key structure 30 or 302.

In the fourth aspect, the electronic apparatus according to a fifth aspect of the disclosure may include the adhesive 60 applied to the joint 50 where an electrode of the key switch 34, 35 or 36 and an electrode of the substrate 40 are joined together. The electronic apparatus may be configured such that the key stopper 37 or 38 is fixed to the substrate 40 by the adhesive 60 applied to the joint 50.

In foregoing configuration, the adhesive 60 is applied to the joint 50, where the electrode of the key switch 34, 35 or 36 and the electrode of the substrate 40 are joined together, thereby achieving enhanced strength of the joint 50. In addition, the key stopper 38, which is fixed to the substrate 40 by the adhesive 60 applied to the joint 50, can avoid a backlash between the key stopper 38 and substrate 40 without the need for an additional separate process step for fixing the key stopper 38 to the substrate 40. The key stopper 38 can thus absorb, with more certainty, the impact of hitting of the key top 31 or 33 against the key switch 34, 35 or 36. This can avoid the electronic apparatus (smartphone 1) from a breakdown with more certainty.

The disclosure is not limited to the foregoing preferred embodiments. Numerous modifications can be devised within the scope of the claims, and a preferred embodiment that is obtained in combination, as necessary, with the technical means disclosed in the respective preferred embodiments is also included in the technical scope of the disclosure. Furthermore, combining the technical means disclosed in the respective preferred embodiments can offer a new technical feature.

What is claimed is:

1. A key structure comprising:
at least one key switch mounted on a surface of a substrate disposed inside a case of an electronic apparatus;
at least one key top inserted in a key through-hole bored in the case, the at least one key top being designed to press the at least one key switch upon undergoing a displacement from outside the case toward inside the case; and
a key stopper abutting, inside the case, the at least one key top that has undergone the displacement, to restrict a further outward-to-inward displacement of the at least one key top.

2. The key structure according to claim 1, wherein
the key stopper has an abutment where the key stopper abuts the at least one key top, and
the abutment is disposed at two locations in a direction orthogonal to a direction of the displacement and to a direction of a normal to the substrate, with the at least one key switch interposed between the two locations.

3. The key structure according to claim 1, wherein
the at least one key switch comprises a plurality of key switches,
the at least one key top comprises a plurality of key tops, and
the key stopper is shared among the plurality of key switches and the plurality of key tops.

4. An electronic apparatus comprising the key structure according to claim 1.

5. The electronic apparatus according to claim 4, comprising
an adhesive applied to a joint where an electrode of the at least one key switch and an electrode of the substrate are joined together, wherein
the key stopper is fixed to the substrate by the adhesive applied to the joint.
